(19) United States
(12) Patent Application Publication
(10) Pub. No.: US 2020/0077568 A1
(43) Pub. Date: Mar. 12, 2020

(54) HAND HELD TRENCHER ASSEMBLY

(71) Applicant: Alexander Hand, Birmingham, AL (US)

(72) Inventor: Alexander Hand, Birmingham, AL (US)

(21) Appl. No.: 16/128,145

(22) Filed: Sep. 11, 2018

(51) Int. Cl. A01C 5/06; E02F 3/08; E02F 3/02

(52) U.S. Cl. CPC A01C 5/064; E02F 3/02; E02F 3/08

(57) ABSTRACT

A hand held trencher assembly for digging a trench with existing weed trimmers includes a weed trimmer that is manipulated by a user. The weed trimmer has a motor, a pole and a drive that is positioned within the pole. The drive is rotatably coupled to the motor such that the motor rotates the drive when the motor is turned on. A trenching unit is removably coupled to the pole such that the trenching unit lies on the ground when the weed trimmer is employed. The trenching unit is releasably coupled to the drive for powering the trenching unit thereby facilitating the trenching unit to dig a trench in the ground.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to trencher devices and more particularly pertains to a new trencher device for digging a trench with existing weed trimmers.

### BRIEF SUMMARY OF THE INVENTION

An embodiment of the disclosure meets the needs presented above by generally comprising a weed trimmer that is manipulated by a user. The weed trimmer has a motor, a pole and a drive that is positioned within the pole. The drive is rotatably coupled to the motor such that the motor rotates the drive when the motor is turned on. A trenching unit is removably coupled to the pole such that the trenching unit lies on the ground when the weed trimmer is employed. The trenching unit is releasably coupled to the drive for powering the trenching unit thereby facilitating the trenching unit to dig a trench in the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a hand held trencher assembly according to an embodiment of the disclosure.

FIG. 2 is a right side view of a trenching unit of an embodiment of the disclosure.

FIG. 3 is a left side view of a trenching unit of an embodiment of the disclosure.

FIG. 4 is a back view of a trenching unit of an embodiment of the disclosure.

FIG. 5 is a cross sectional view taken along line 5-5 of FIG. 4 of an embodiment of the disclosure.

### DETAILED DESCRIPTION OF THE INVENTION

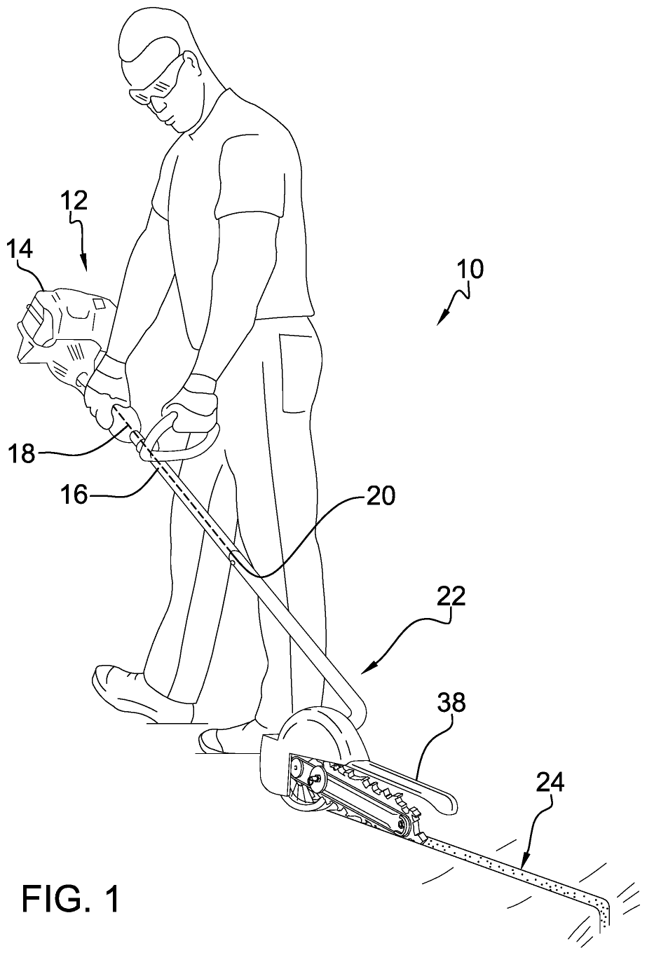

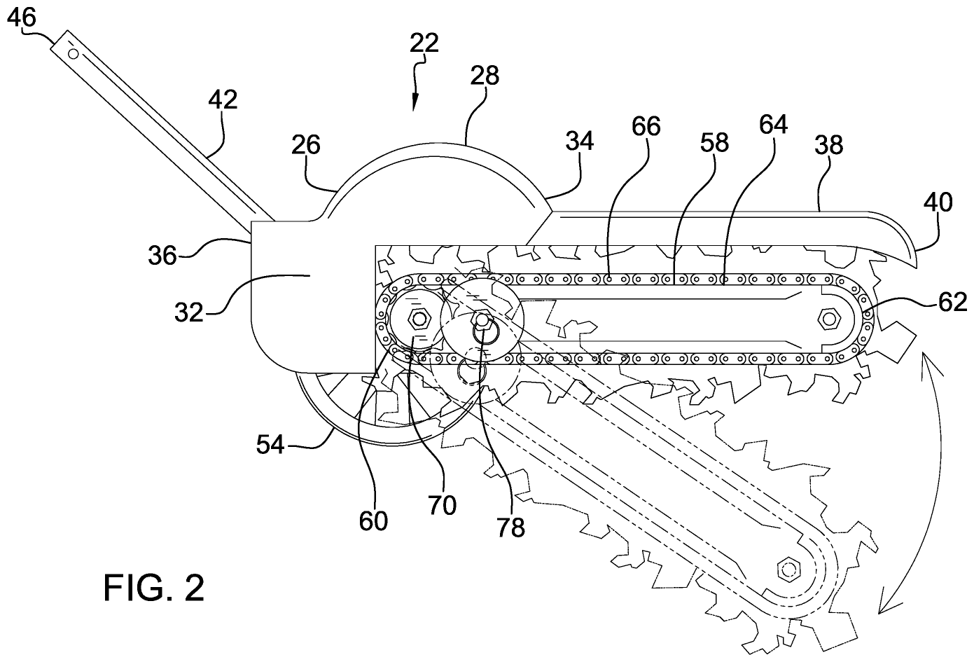

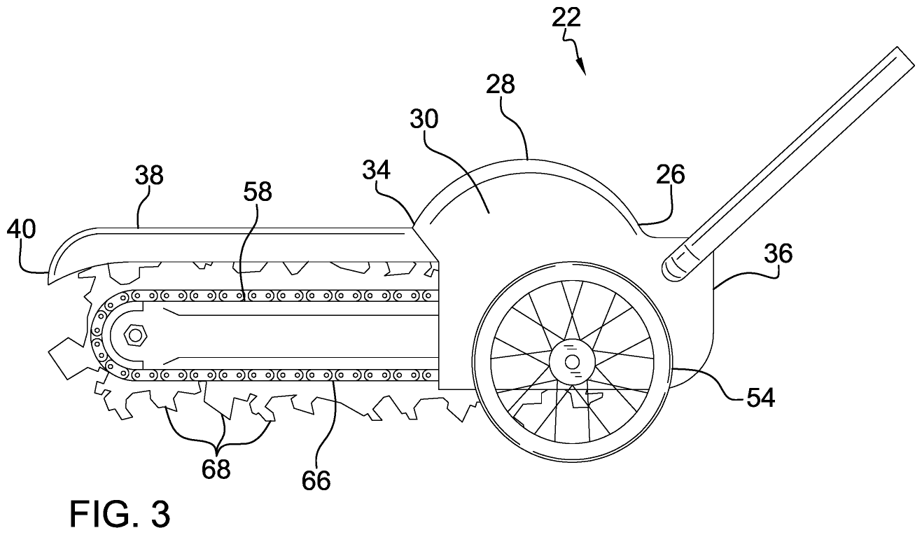

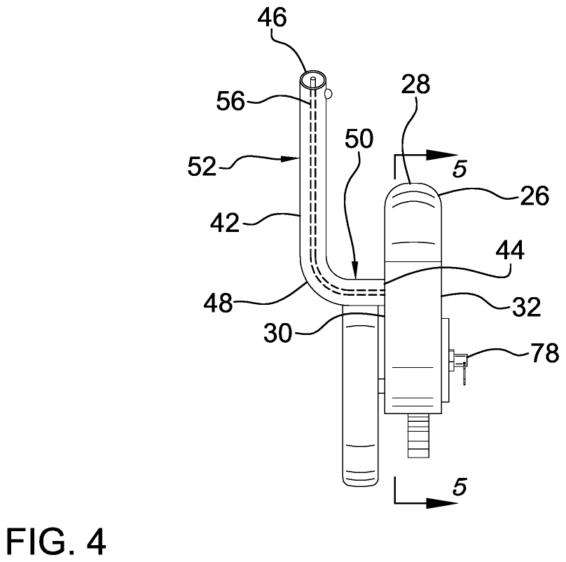

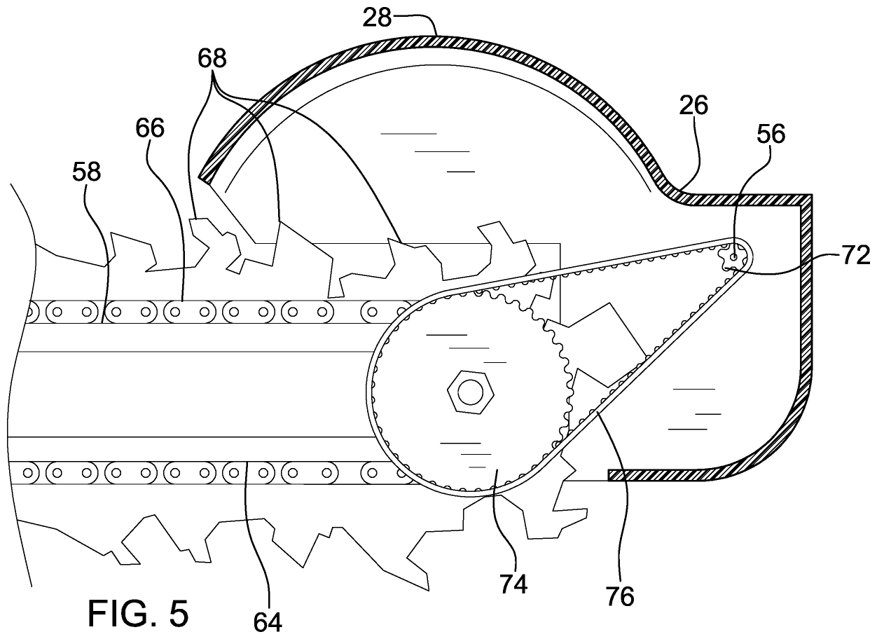

With reference now to the drawings, and in particular to FIGS. 1 through 5 thereof, a new trencher device embodying the principles and concepts of an embodiment of the disclosure and generally designated by the reference numeral 10 will be described.

As best illustrated in FIGS. 1 through 5, the hand held trencher assembly 10 generally comprises a weed trimmer 12 that is manipulated by a user. The weed trimmer 12 has a motor 14, a pole 16 and a drive 18 that is positioned within the pole 16. The drive 18 is rotatably coupled to the motor 14 such that the motor 14 rotates the drive 18 when the motor 14 is turned on. Additionally, the pole 16 has a distal end 20 with respect to the motor 14. The weed trimmer 12 may be a gas powered weed trimmer 12 manufactured by Stihl® or other manufacturers that are commonly employed by professional landscapers.

A trenching unit 22 is provided and the trenching unit 22 is removably coupled to the pole 16 such that the trenching unit 22 lies on the ground when the weed trimmer 12 is employed. The trenching unit 22 is releasably coupled to the drive 18 for powering the trenching unit 22 thereby facilitating the trenching unit 22 to dig a trench 24 in the ground. The trenching unit 22 comprises a housing 26 that has a top wall 28 extending between a first lateral wall 30 and a second lateral wall 32. The top wall 28 is concavely arcuate between a front side 34 and a rear side 36 of the housing 26 such that the housing 26 has a fender shape. The housing 26 has a shield portion 38 extending forwardly away from the front side 34 of the housing 26. The shield portion 38 has a distal end 40 with respect to the front side 34 and the shield portion 38 is elongated between the front side 34 and the distal end 20.

The trenching unit 22 includes a rod 42 that has a first end 44 and a second end 46; each of the first 44 and second 46 ends is open and the rod 42 is hollow. The rod 42 has a bend 48 thereon defining a first portion 50 of the rod 42 forming an angle with a second portion 52 of the rod 42. The first end 44 is coupled to the first lateral wall 30 of the housing 26 having the first portion 50 of the rod 42 angling upwardly and rearwardly away from the housing 26. Additionally, the second end 46 releasably engages the distal end 20 of the pole 16. The distal end 20 of the pole 16 may include a locking mechanism similar to that of the Stihl® KombiSystem or other weed trimmer 12 that is manufactured to accept a variety of landscaping attachments. The rod 42 includes a locking mechanism that is designed to be compatible with the locking mechanism on the pole 16.

A wheel 54 is rotatably coupled to the first lateral wall 30 of the housing 26. The wheel 54 rolls along the ground when the rod 42 is releasably coupled to the pole 16 for guiding the trenching unit 22. Additionally, the wheel 54 supports the weight of the trenching unit 22 thereby reducing fatigue for the user. A drive shaft 56 is rotatably positioned within the rod 42 and the drive shaft 56 engages the drive 18 of the weed trimmer 12 when the second end 46 of the rod 42 is releasably coupled to the distal end 20 of the pole 16. Thus, the motor 14 rotates the drive shaft 56 when the motor 14 is turned on. Additionally, the drive shaft 56 extends through the first lateral wall 30 of the housing 26.

A chain bar 58 is included that has a primary end 60, a secondary end 62 and an outer edge 64. The chain bar 58 may be a chain bar that is similar in construction and size to chain bars used on chainsaws. The primary end 60 of the chain bar 58 is pivotally coupled to the housing 26 having the chain bar 58 being positioned between the first 30 and second 32 lateral walls of the housing 26. Additionally, the chain bar 58 is oriented collinear with and is positioned beneath the shield portion 38 of the housing 26. A trenching chain 66 is positioned around the chain bar 58, the trenching chain 66 extends around an entire perimeter of the outer edge 64 of the chain bar 58 and the trenching chain 66 has a plurality of claws 68 thereon for digging. The trenching chain 66 may be a miniaturized version of existing trenching chains used on full sized trenching machines.

A sprocket 70 is rotatably coupled to the chain bar 58 and the sprocket 70 engages the trenching chain 66 for urging the trenching chain 66 to travel around the chain bar 58. A first gear 72 is rotatably coupled to an interior surface of the first lateral wall 50 of the housing 26. The drive shaft 56 engages the first gear 72 such that the drive shaft 56 rotates the first gear 72 when the motor 14 is turned on. A second gear 74 is rotatably coupled to the chain bar 58 and the second gear 74 engages the sprocket 70 such that the second gear 74 rotates the sprocket 70.

A belt 76 extends around the first and second gear 74s such that the first gear 72 rotates the second gear 74 when the motor 14 is turned on. In this way the sprocket 70 is rotated to urge the trenching chain 66 to travel around the chain bar 58. A pin 78 extends through the chain bar 58 and engages the housing 26 at a selected one of a plurality of engagement points in the housing 26. In this way the chain bar 58 is retained at a selected downward angle for digging the trench 24 to a selected depth. The trenching chain 66 may be capable of digging the trench 24 to a depth ranging between approximately 18.0 inches deep and 1.0 inch deep. In this way the trenching chain 66 can dig the trench 24 in a yard or other landscaped area for installing sprinkler lines, cable television, telephone lines and any other object that is commonly buried in landscaped areas.

The discrete nature of the trenching unit 22 as compared to full sized trenching machines facilitates the trench 24 to be dug with minimal impact on the surrounding area. Thus, the trenching unit 22 enhances efficiency with respect to installing buried objects in a landscaped area by minimizing the amount of cleanup and repair to the surrounding area. Additionally, the modular nature of the trenching unit 22 facilitates the trenching unit 22 to be employed with existing weed trimmer technology that is already commonly owned by professional landscapers. In this way the professional landscapers can begin performing trench work with existing weed trimming equipment and avoid having to purchase or rent a full sized trenching machine.

In use, the second end 46 of the rod 42 is releasably coupled to the distal end 20 of the pole 16 thereby facilitating the drive shaft 56 to engage the drive 18. The weed trimmer 12 is manipulated to position both the wheel 54 and the trenching chain 66 on the ground. The motor 14 is started thereby urging the trenching chain 66 to travel around the chain bar 58, thereby digging the trench 24. The weed trimmer 12 is urged along a selected route thereby facilitating the trench 24 to be dug along the selected route. Thus, the trench 24 can be dug in a landscaped area, such as a residential yard or the like, without requiring the use of heavy equipment. In this way the surrounding area with respect to the trench 24 is disturbed as little as possible, thereby minimizing cleanup and repair work commonly associated with trenching.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hand held trencher assembly being configured to dig a trench in the ground, said assembly comprising:
a weed trimmer being manipulated by a user, said weed trimmer having a motor, a pole and a drive being positioned within said pole, said drive being rotatably coupled to said motor such that said motor rotates said drive when said motor is turned on, said pole having a distal end with respect to said motor; and
a trenching unit being removably coupled to said pole such that said trenching unit lies on the ground when said weed trimmer is employed, said trenching unit being releasably coupled to said drive for powering said trenching unit wherein said trenching unit is configured to dig a trench in the ground, said trenching unit comprising
a housing having a top wall extending between a first lateral wall and a second lateral wall, said top wall being concavely arcuate between a front side and a rear side of said housing, said housing having a shield portion extending forwardly away from said front side of said housing, said shield portion having a distal end with respect to said front side, said shield portion being elongated between said front side and said distal end, and
a rod having a first end and a second end, each of said first and second ends being open, said rod being hollow, said rod having a bend thereon defining a first portion of said rod forming an angle with a second portion of said rod, said first end being coupled to said first lateral wall of said housing having said first portion of said rod angling upwardly and rearwardly away from said housing, said second end releasably engaging said distal end of said pole.

2. (canceled)

3. (canceled)

4. The assembly according to claim 1, further comprising a wheel being rotatably coupled to said first lateral wall of said housing wherein said wheel is configured to roll along the ground when said rod is releasably coupled to said pole for guiding said trenching unit.

5. The assembly according to claim 1, further comprising a drive shaft being rotatably positioned within said rod, said drive shaft engaging said drive of said weed trimmer when said second end of said rod is releasably coupled to said distal end of said pole such that said motor rotates said drive shaft when said motor is turned on, said drive shaft extending through said first lateral wall of said housing.

6. The assembly according to claim 5, further comprising:
a chain bar having a primary end, a secondary end and an outer edge, said primary end being pivotally coupled to said housing having said chain bar being positioned between said first and second lateral walls of said housing, said chain bar being oriented collinear with and being positioned beneath said shield portion of said housing; and
a trenching chain being positioned around said chain bar, said trenching chain extending around said outer edge of said chain bar, said trenching chain having a plurality of claws thereon for digging.

7. The assembly according to claim 6, further comprising a sprocket being rotatably coupled to said chain bar, said sprocket engaging said trenching chain for urging said trenching chain to travel around said chain bar.

8. The assembly according to claim 7, further comprising a first gear being rotatably coupled to an interior surface of said first lateral side of said housing, said drive shaft engaging said first gear such that said drive shaft rotates said first gear when said motor is turned on.

9. The assembly according to claim 8, further comprising
a second gear being rotatably coupled to said chain bar, said second gear engaging said sprocket such that said second gear rotates said sprocket; and
a belt extending around said first and second gears such that said first gear rotates said second gear when said motor is turned on thereby rotating said sprocket to urge said trenching chain to travel around said chain bar.

10. The assembly according to claim 6, further comprising a pin extending through said chain bar and engaging said housing at a selected one of a plurality of engagement points in said housing thereby retaining said chain bar at a selected downward angle wherein said trenching chain is configured to dig a trench of a selected depth.

11. A hand held trencher assembly being configured to dig a trench in the ground, said assembly comprising:
a weed trimmer being manipulated by a user, said weed trimmer having a motor, a pole and a drive being positioned within said pole, said drive being rotatably coupled to said motor such that said motor rotates said drive when said motor is turned on, said pole having a distal end with respect to said motor; and
a trenching unit being removably coupled to said pole such that said trenching unit lies on the ground when said weed trimmer is employed, said trenching unit being releasably coupled to said drive for powering said trenching unit wherein said trenching unit is configured to dig a trench in the ground, said trenching unit comprising:
a housing having a top wall extending between a first lateral wall and a second lateral wall, said top wall being concavely arcuate between a front side and a rear side of said housing, said housing having a shield portion extending forwardly away from said front side of said housing, said shield portion having a distal end with respect to said front side, said shield portion being elongated between said front side and said distal end,
a rod having a first end and a second end, each of said first and second ends being open, said rod being hollow, said rod having a bend thereon defining a first portion of said rod forming an angle with a second portion of said rod, said first end being coupled to said first lateral wall of said housing having said first portion of said rod angling upwardly and rearwardly away from said housing, said second end releasably engaging said distal end of said pole;
a wheel being rotatably coupled to said first lateral wall of said housing wherein said wheel is configured to roll along the ground when said rod is releasably coupled to said pole for guiding said trenching unit;
a drive shaft being rotatably positioned within said rod, said drive shaft engaging said drive of said weed trimmer when said second end of said rod is releasably coupled to said distal end of said pole such that said motor rotates said drive shaft when said motor is turned on, said drive shaft extending through said first lateral wall of said housing;
a chain bar having a primary end, a secondary end and an outer edge, said primary end being pivotally coupled to said housing having said chain bar being positioned between said first and second lateral walls of said housing, said chain bar being oriented collinear with and being positioned beneath said shield portion of said housing;
a trenching chain being positioned around said chain bar, said trenching chain extending around said outer edge of said chain bar, said trenching chain having a plurality of claws thereon for digging;
a sprocket being rotatably coupled to said chain bar, said sprocket engaging said trenching chain for urging said trenching chain to travel around said chain bar;
a first gear being rotatably coupled to an interior surface of said first lateral side of said housing, said drive shaft engaging said first gear such that said drive shaft rotates said first gear when said motor is turned on;
a second gear being rotatably coupled to said chain bar, said second gear engaging said sprocket such that said second gear rotates said sprocket;
a belt extending around said first and second gears such that said first gear rotates said second gear when said motor is turned on thereby rotating said sprocket to urge said trenching chain to travel around said chain bar; and
a pin extending through said chain bar and engaging said housing at a selected one of a plurality of engagement points in said housing thereby retaining said chain bar at a selected downward angle wherein said trenching chain is configured to dig a trench of a selected depth.
